(19) United States
(12) Patent Application Publication
(10) Pub. No.: US 2007/0234285 A1
(43) Pub. Date: Oct. 4, 2007

(54) Determining the portability of an application program from a source platform to a target platform

(76) Inventors: Alfredo V. Mendoza, Georgetown, TX (US); Chakarat Skawratananond, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/364,621

(22) Filed: Feb. 28, 2006

(51) Int. Cl. G06F 9/44; G06F 9/45

(52) U.S. Cl. 717/114; 717/141

(57) ABSTRACT

Providing the developer porting an application program from a source operating system platform to a target operating system platform with a list of API functions supported by the source operating system platform on which the application program is running but unsupported by the target platform. The implementation includes generating a list of interface functions in said application program supported by the source platform and comparing this list of source supported application program functions with a list of prototype application program functions supported by the target platform. As a result of the comparison, there is generated an output list of the application program interface functions supported by said source platform but unsupported by said target platform.

### TECHNICAL FIELD

The present invention relates to implementations for the creation of computer application programs, and particularly for determining the portability for application programs created for a source operating system platform to other operating system platforms.

### BACKGROUND OF RELATED ART

The last computer generation has been marked by a technological revolution driven by the convergence of the data processing and consumer electronics industries together with the explosion of the World Wide Web (Web) or Internet (these two terms are considered interchangeable for purposes of the present application). As a result, extraordinary worldwide communication channels and resources have become available to businesses, and this has forever changed how many businesses and industries develop products, as well as the time cycles of such product development.

Nowhere are these dramatic changes in product development more apparent than in the development, testing and eventual production of computer software products. Over its first forty years, prior to the 1980's, the software development environment was one in which an individual or a small dedicated group willing to put in long hard hours could create “elegant” software or “killer applications” directed to and effective in one or more of the limited computer system environments existing at the time.

Unlike hardware or industrial product development, the development of software did not require substantial investment in capital equipment and resources. Consequently, in the software product field, the business and consumer marketplace to which the software is directed has traditionally expected short development cycles from the time that a computer need and demand became apparent to the time that a commercial software product fulfilling the need became available.

Unfortunately, with the explosion of computer usage and the resulting wide diversity of computer systems that must be supported by, or at least not be incompatible with, each newly developed computer application program product, the development cycles have become very complex. Even when the software product development is an upgrade of an existing product, every addition, subtraction or modification of the program could have an insignificant or a profound effect on another operating system which must be supported.

This changed development environment has caused many traditional and responsible software development houses to take the time and make the effort to resolve all potential incompatibilities with all existing and standard software before the new developed software products were commercially released. Unfortunately, there was often fierce competition from software product entrepreneurs that may rush to the market with unresolved incompatibilities. This, in turn, led to a distrust of new software products by consumers and businesses, i.e. a new software product will lead to down time until incompatibilities are resolved.

Accordingly, the computer software development industries have been working over the past several years toward the goal of creating application programs with the shortest development cycles and with the fewest incompatibilities with standard existing software, and particularly with some of the newer operating system platforms.

### SUMMARY OF THE PRESENT INVENTION

The present invention provides an implementation to expedite application program development. It is customary for developers of application programs to develop the program for a primary operating system platform, e.g. WindowsXP™, and, due to customer demand, to try to port the application program to another operating system platform, e.g. Linux™. With the proliferation of operating systems, it is not unusual for a developer who created the application program code using a source operating system platform to be uninformed as to significant differences between the source platform and the target platform functions. In the development of application programs, the platform differences that most often interfere with the porting of application programs from one operating system platform to another platform are differences of the operating system platforms in providing Application Program Interfaces (APIs) support.

The present invention provides a quick and effective implementation for providing the developer with a list of API functions supported by the source operating system platform on which the application program is running but unsupported by the target platform to which the developer is trying to port the application program.

In its broadest aspects, the present invention provides a method or program for determining the portability of an application program from a source operating system platform to a target operating system platform comprising generating a list of interface functions in the application program supported by the source platform, and comparing this list of source supported application program functions with a list of prototype application program functions supported by the target platform. As a result of the comparison, there is generated an output list of the API functions supported by said source platform but unsupported by said target platform. This list is returned to the developer who may then evaluate the effect of these differences to his porting procedures.

At the source platform, the list of source supported API functions is preferably generated by providing a table of all prototype API functions supported by the source platform, and comparing the functions in the source supported application program (determined by parsing) to the table of interface functions, and then outputting a list of functions in the application program which compare to functions in the table, i.e. API functions supported by the source platform.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic general view of a network of a plurality of computer stations, each used by software vendors for developing application programs on a source operating system platform communicating over the Web with target operating system platforms to which the developer vendors are porting the application programs;

FIG. 2 is a block diagram of a data processing system including a central processing unit and network connections via a communications adapter that is capable of functioning as one of the developer stations using the source operating system platforms, the computers using the target operating system platforms or any of the intermediate servers in FIG. 1;

FIG. 3 is an illustrative flowchart describing the setting up of the process of the present invention for the determination of APIS supported by the source platform but unsupported by the target platform;

FIG. 4 is a flowchart of an illustrative run of the process set up in FIG. 3;

FIG. 5 is an illustrative example of the comparison made at the target operating system platform of the list of API functions in the application program under development that are supported by the source operating system platform with a table of the API functions supported by the target operating system platform; and

FIG. 6 is another illustrative example of the comparison made at the target operating system platform of the list of API functions in the application program under development that are supported by the source operating system platform with a table of the API functions supported by the target operating system platform.

### DETAILED DESCRIPTION OF THE PREFERRED EMBODIMENT

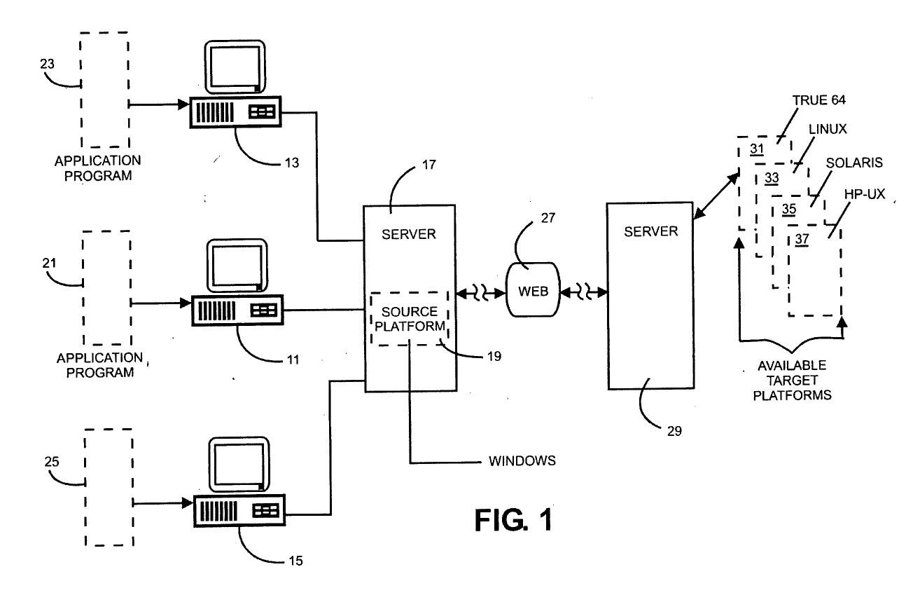

Referring to FIG. 1, a diagrammatic general view of a network of a plurality of computer stations, 11, 13 and 15, each used by software vendors for developing application programs, e.g. 21, 23 and 25 on a source operating system platform. This platform may be made available to the computer stations from a server 17 providing the source operating system platform 19 to the vendors respectively developing the application programs to be operative on the source operating system platform 19. The program of the present invention for determining the portability of the application programs being developed to other operating system platforms may also be resident on server 17 and distributed to the developer computer stations 11, 13 and 15 as required. As will be subsequently described in greater detail, the developer station generates a list of API functions required in the application program being developed and supported by the source operating system platform. This API supported list is transmitted via server 17 through a communication network, e.g. Web 27, to a server 29 supported computer station where any of other available operating system platforms (target platforms), e.g. True64 ™ 31, Linux™ 33, Solaris™ 35 and HP-UX™ 37, may be accessed. In the illustration of FIG. 1, Windows is shown as the source platform. It is just as likely that a Windows operating system could be the target platform and one the of other operating systems: True64 ™ 31, Linux™ 33, Solaris™ 35 and HP-UX™ 37, could be the source platform. As will be subsequently described in greater detail, the received list of API functions supported by the source platform is compared to a table of prototype API functions supported by the selected target operating system platform. As a result of this comparison, an output list is generated of API functions required by the application program under development that is supported by the source platform but unsupported by the target platform. This resulting list is returned via server 29, Web 27 and server 17 to the computer station 11, 13 or 15 of the application program developer so that the developer may assess and use such data in the development process.

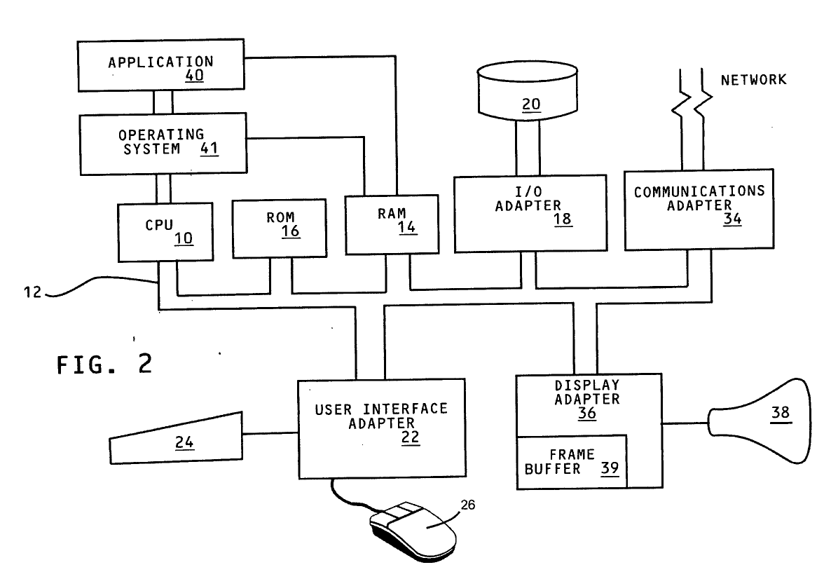

FIG. 2 is a block diagram of a data processing system including a central processing unit (CPU) and network connections via a communications adapter that is capable of functioning as one of the developer stations using the source operating system platforms, the computer using the target operating system platforms or any of the intermediate servers shown in FIG. 1. A CPU 10, such as one of the PC microprocessors or workstations, e.g. RISC System/6000™ series available from International Business Machines Corporation (IBM), or Dell or Lenovo PC microprocessors, is provided and interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 14. These programs, in the appropriate servers or computer stations include the programs of the present invention for determining the portability of an application program from a source operating system platform to a target operating system platform that will hereinafter be described in greater detail. A Read Only Memory (ROM) 16 is connected to CPU 10 via bus 12 and includes the Basic Input/Output Systems (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with the outside network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs of this invention. In the computers or servers having a display, there is a display adapter 36 including a frame buffer 39 that is a storage device that holds a representation of each pixel on the display screen 38. Images may be stored in frame buffer 39 for display on monitor 38. By using the aforementioned I/O devices, a user is capable of inputting information to the system through keyboard 24 or mouse 26 and receiving output information from the system via display 38.

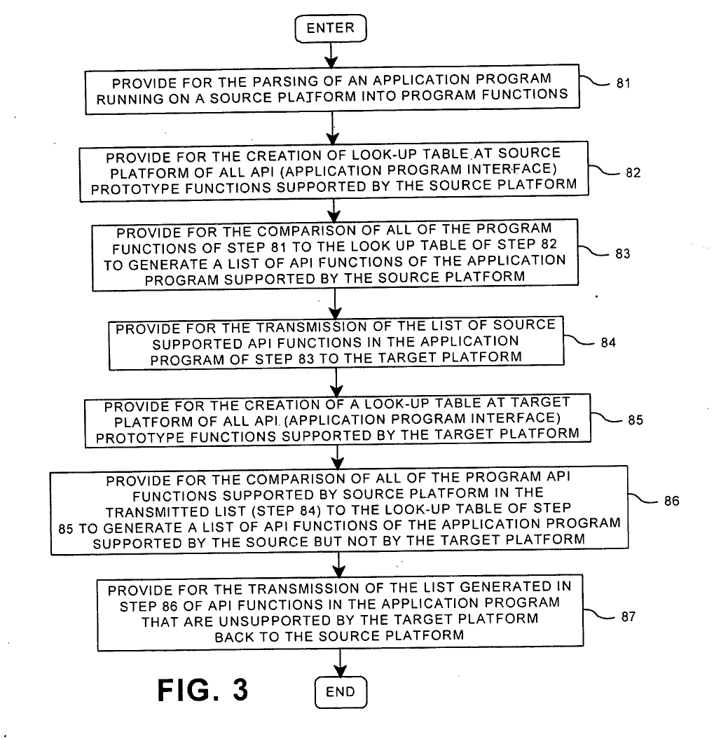

Now, with reference to FIG. 3, there will be described a process implemented by a program according to the present invention for porting an application program developed for a source operating system platform to a target operating system platform. First, provision must be made for the parsing of the application program running on the source platform into program functions, step 81. Provision is also made for the creation of a look-up table at the source platform of all API prototype functions supported by the source platform, step 82. Then, there is provided for the comparison of all of the program functions of the application program parsed in step 81 to the look-up table of step 82 to generate a list of API functions required for the application program that are supported by the source platform, step 83. Provision is then made for the transmission of the list of source supported API functions in the application program generated in step 83 to the target platform, step 84. Provision is made for the creation at the target platform of a look-up table of all API prototype functions supported by the target platform, step 85.

At this point, a comparison is provided for between all of the application program API functions supported by the source platform in the list transmitted (step 84) and the look-up table of step 85 to generate a list of API functions of the application program supported by the source platform but not by the target platform, step 86. As a final step, provision is made for the transmission of the list of API functions of the application program supported by the source platform but not by the target platform of step 86 back to the source platform, step 87, where the list may be used by the developer for assessing and using such data in the development process.

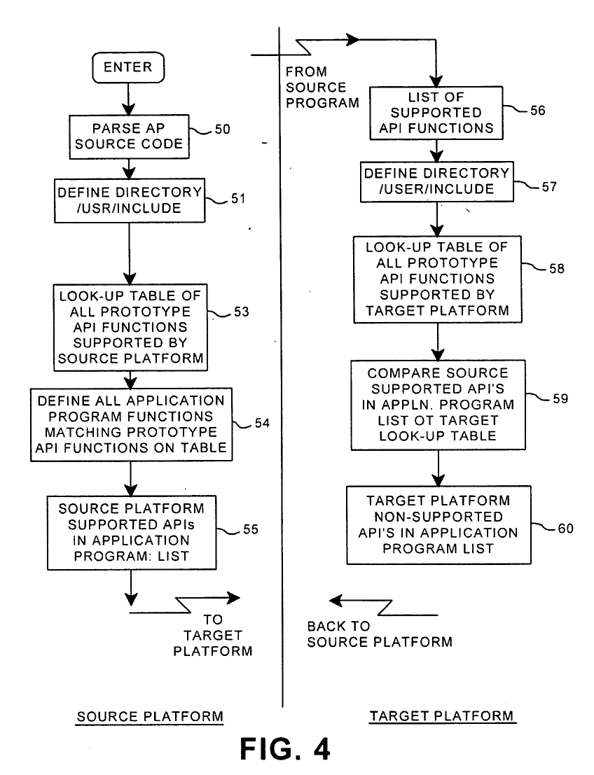

The running of the process set up in FIG. 3 will now be described with respect to the flowchart of FIG. 4. An application program developer has developed an application program on a source platform and wishes to determine its portability to a target operating system platform. He parses the application program source code into the program files, i.e. functions, step 50. An/usr/include directory is defined for the source platform that includes all prototype functions provided by the source platform including all API functions, step 51. From this directory that includes all source platform functions, there may be organized a look-up table of all of the prototype API functions supported by the source program, step 53. Next, using this table and the application program, there is defined by a comparison to the look-up table all application program functions matching API functions in the look-up table, step 54. These matching API functions are output as a list of source platform supported APIs in the application program, step 55. The list is transmitted to the selected target platform where it is input, step 56. At this point, an/usr/include directory is defined for the target platform that includes all prototype functions provided by the target platform including all API functions, step 57. From this directory that includes all target platform functions, there may be organized a look-up table of all of the prototype API functions supported by the target platform, step 58. Next, using this table and the list of API functions supported by the source, there is defined by a comparison, step 59, to the look-up table, all APIs in the application program that are supported by the source platform but not supported by the target platform. This list is output 60, and returned to the source platform where the application program is under development.

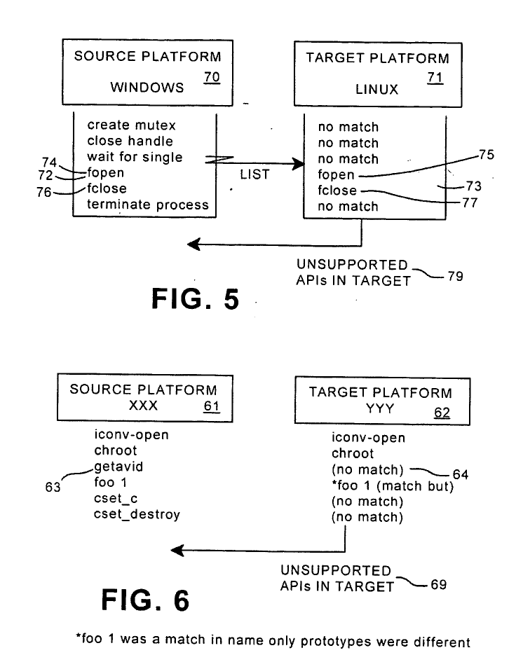

Referring to FIGS. 5 and 6, there will be illustrated two Examples of the comparison at the target operating system platform of the list of source platform supported APIs in the application programs with the table in the target operating system platform of all APIS supported by the target platform. In the example in FIG. 5, the list 72 of APIs in the application under development supported by the source platform 70: WindowsXP™ has been transmitted to the target platform 71: Linus™ where a comparison is being made to a list 75 of APIs supported by the target platform. For simplicity of illustration, there are only two matches shown: fopen 74 and fclose 76 with corresponding fopen 75 and fclose 77 supported by the target platform. As a result, list 79 of API functions supported by the source platform but unsupported by the target platform being transmitted back to the source platform would include the CreateMutex, CreateHandle, WaitforSingle and TerminateProcess API functions.

In the Example of FIG. 6, the list 63 of APIs in the application under development supported by the source platform 61: XXX has been transmitted to the target platform 62: YYY where a comparison is being made to a list 64 of APIs supported by the target platform, there are two matches shown: iconv_open and chroot are supported by both platforms. Four functions supported by the source platform are unsupported by the target platform including the “foo 1” function of the source program that has a counterpart term “foo 1” in the target platform but in name only. The foo 1 function in the target platform is different from that of the source program. As a result, list 69 of API functions supported by the source platform but unsupported by the target platform being transmitted back to the source platform would include the getavid, fool, CSET_Create and CSET_Destroy API functions.

Although certain preferred embodiments have been shown and described, it will be understood that many changes and modifications may be made therein without departing from the scope and intent of the appended claims.

What is claimed is:

1. A method for determining the portability of an application program from a source operating system platform to a target operating system platform comprising:
generating a list of interface functions in said application program supported by the source platform;
comparing said list of source supported application program functions with a list of prototype application program functions supported by the target platform; and
generating an output list of said application program interface functions supported by said source platform but unsupported by said target platform.

2. The method of claim 1 wherein said step of generating said list of source supported application program functions comprises:
providing a table of all prototype application program interface functions supported by the source platform;
comparing the functions in said source supported application program to said table of interface functions; and
outputting a list of functions in said application program that compare to functions in said table.

3. The method of claim 2 wherein said source supported application program is parsed into the individual functions to be compared to said table of prototype interface functions.

4. The method of claim 3 wherein said parsing includes the steps of:
running the source code of said application program being parsed; and
defining files from said source code respectively representative of said individual functions to be compared to the list of prototype application program functions.

5. The method of claim 4 wherein said table of all prototype application program interface functions supported by the source platform is provided by said parsing including the steps of:
parsing a directory of all prototype files in said source operating system; and
parsing said prototype application program interface functions from said directory.

6. The method of claim 3 further including the step of transmitting said list of source supported application program functions from said source operating system platform to said target operating system platform.

7. The method of claim 6 further including the step of transmitting said output list of said application program interface functions unsupported by said target platform back to said source operating system platform.

8. A system for determining the portability of an application program from a source operating system platform to a target operating system platform comprising:
means for generating a list of interface functions in said application program supported by the source platform;
means for comparing said list of source supported application program functions with a list of prototype application program functions supported by the target platform; and
means for generating an output list of said application program interface functions supported by said source platform but unsupported by said target platform.

9. The system of claim 8 wherein said means for generating said list of source supported application program functions comprises:
means for providing a table of all prototype application program interface functions supported by the source platform;
means for comparing the functions in said source supported application program to said table of interface functions; and
means for outputting a list of functions in said application program that compare to said table functions.

10. The system of claim 9 further including means for parsing said source supported application program into the individual functions to be compared to said table of prototype interface functions.

11. The system of claim 10 wherein said means for parsing includes:
means for running the source code of said application program being parsed; and
means for defining files from said source code respectively representative of said individual functions to be compared.

12. The system of claim 10 further including means for transmitting said list of source supported application program functions from said source operating system platform to said target operating system platform.

13. The system of claim 12 further including means for transmitting said output list of said application program interface functions unsupported by said target platform back to said source operating system platform.

14. The system of claim 13 wherein both said means for transmitting said list of source supported application program functions and said means for transmitting said output list of said application program interface functions unsupported by said target platform are network communication means.

15. A computer program having program code included on a computer readable medium for determining the portability of an application program from a source operating system platform to a target operating system platform comprising:
means for generating a list of interface functions in said application program supported by the source platform;
means for comparing said list of source supported application program functions with a list of prototype application program functions supported by the target platform; and
means for generating an output list of said application program interface functions supported by said source platform but unsupported by said target platform.

16. The computer program of claim 15 wherein said means for generating said list of source supported application program functions comprises:
means for providing a table of all prototype application program interface functions supported by the source platform;
means for comparing the functions in said source supported application program to said table of interface functions; and
means for outputting a list of functions in said application program that compare to said table functions.

17. The computer program of claim 16 further including means for parsing said source supported application program into the individual functions to be compared to said table of prototype interface functions.

18. The computer program of claim 17 wherein said means for parsing includes:
means for running the source code of said application program being parsed; and
means for defining files from said source code respectively representative of said individual functions to be compared to the list of prototype application program functions.

19. The computer program of claim 16 wherein said means for providing a table of all prototype application program interface functions supported by the source platform includes:
means for parsing a directory of all prototype files in said source operating system; and
means for parsing said prototype application program interface functions from said directory.

20. The computer program of claim 19 further including:
means for transmitting said list of source supported application program functions from said source operating system platform to said target operating system platform; and
means for transmitting said output list of said application program interface functions unsupported by said target platform back to said source operating system platform.
